(19) United States
(12) Patent Application Publication
(10) Pub. No.: US 2011/0219852 A1
(43) Pub. Date: Sep. 15, 2011

(54) IMPACT MONITORING APPARATUS

(76) Inventor: Stephen P. Kasten, Prescott, AZ (US)

(21) Appl. No.: 13/044,940

(22) Filed: Mar. 10, 2011

Related U.S. Application Data
(60) Provisional application No. 61/312,514, filed on Mar. 10, 2010.

(51) Int. Cl. G01N 3/30

(52) U.S. Cl. 73/12.04; 73/12.01

(57) ABSTRACT

An impact monitoring apparatus that includes a support member made of an elastic material capable of being attached to or worn by a user and at least one force measuring element attached to the support member. The force measuring elements may be easily removed from the support member. The force measuring element may include an indicator capable of indicating the amount of force or impact sustained by the user. If the force measuring element does not include an indicator, then the apparatus may further include an indicator that is associated with the force measuring element.

### CROSS-REFERENCE TO RELATED APPLICATIONS

This application claims priority to provisional patent application having Ser. No. 61/312,514, filed Mar. 10, 2010, which is herein incorporated by reference in its entirety.

### FIELD OF INVENTION

The present invention is generally directed to an impact monitoring apparatus for an individual's body and/or specific parts of an individual's body. More particularly, the present invention is directed to an impact monitoring apparatus for the body which includes a stretch fabric support member capable of being attached to a user, mounted on a user, or worn by a user, and at least one force measuring element attached to the support member. The force measuring element may include an indicator that is capable of indicating the amount of force or impact that is experienced by a user of the impact monitoring apparatus. Alternatively, the impact monitoring apparatus may also include an indicator associated with the force measuring element if the force measuring element does not already include an indicator. Although there are a multitude of applications for the impact monitoring apparatus of the present invention, the present invention is primarily intended for use in the field of contact sports and motor sports where the potential exists for severe head injuries.

### BACKGROUND OF THE INVENTION

Determining the severity of head injuries incurred by athletes during competition, especially those in contact sports and high risk sports, and whether or not it is safe for them to resume competing is difficult and often fraught with risk. In the past, athletes suffering from head injuries may not have been given sufficient time to recover before returning to their sport and, as a result, they sustained severe and sometimes permanent brain injury. Moreover, recent studies have indicated that repeated head trauma in professional football players may be the cause of reported dementia symptoms that are five times higher than in the general population by age fifty.

Several reasons contribute to the difficulty in determining the severity of head injuries in sports and the relative safety of allowing a player to return to competition. First, in the vast majority of athletic endeavors, coaches and players are amateurs. Their medical training is minimal and they cannot easily recognize a dangerous situation for a particular player. Second, guidelines for returning to competition after a head injury vary widely. They are usually subjective and often left up to the coach who may or may not have made a proper assessment of the player and his injury. Third, there is no objective data available that suggests what the proper protocol should be when an athlete incurs a head injury

In the past, sports equipment manufacturers and sports injury professionals have used high speed film and in some cases accelerometers installed in specific locations within helmets or mouth guards to determine the severity of impact and the likely acceleration forces incurred by an athlete's head. While helpful in developing improved coaching techniques and sports equipment, these devices and methods do not provide a practical path to providing objective data for individuals on the field or in competition.

There is a need for a way to obtain accurate objective data, such as the force of impact endured by a player or athlete during competition at the time of impact, in order to appropriately and safely determine what the protocol should be for treating that player and for determining whether or not they should be allowed to resume competition. The present invention provides an apparatus for obtaining such objective data.

### SUMMARY OF THE INVENTION

The present invention is directed to an impact monitoring apparatus that enables one to measure the degree of force or acceleration that is incurred by a user of the apparatus when the user sustains an impact or suffers an injury during competition. The apparatus can measure the force of impact to any part of a user's body but is particularly useful in measuring the force of impact to a user's head.

The impact monitoring apparatus of the present invention includes a support member comprising an elastic material that is capable of being attached to, or worn by, a user and one or more force measuring elements that are attached to, or retained within, the elastic support member. In one exemplary embodiment, the force measuring elements each include an indicator that is capable of indicating an amount of force of an impact that is experienced by the user. For example, the force measuring element may comprise a receptacle containing a colored liquid held in suspension and the indicator may comprise the release of the colored liquid into the receptacle when the surface tension of the colored liquid is disrupted by a user being subjected to an impact.

In another exemplary embodiment, the force measuring element may comprise a switch, such as an inertia switch, that is actuated upon receiving a specific level of force and the impact monitoring apparatus may further include an indicator circuit that is associated with, or connected to, each of the switches which indicates the level of force received when a switch is activated. In yet another exemplary embodiment, the indicator circuit may indicate which of the switches are activated so that one can better evaluate how much impact the skull itself, or some other body part, is absorbing. The indicator circuit may not be located within or on the support member and may instead be located on another part of the user or the user's equipment. The switches may be capable of being automatically reset after being actuated.

In yet another exemplary embodiment, the force measuring element may comprise an accelerometer and each accelerometer may include circuitry capable of data collection and storage. In addition, the circuitry may be capable of downloading the data to other storage media and the circuitry may also be capable of wirelessly transmitting the data in real-time so that real-time analysis of the data can be performed.

The support member is easily removable from the user and, in one exemplary embodiment, the support member may comprise a head band, a skull cap, or a balaclava for monitoring the impact sustained by a user's head. The support member may include one or more VELCRO fasteners and/or one or more pockets for retaining the force measuring elements. In another exemplary embodiment, the support member may include one or more clear windows through which the force measuring elements can be visually inspected. In still another exemplary embodiment, the force measuring elements may be easily removable from the support member to allow for immediate inspection. The support member is designed to allow for some adjustment of the exact location of the force measuring elements. For example, multiple pockets that exceed the number of force measuring elements may be sewn into the support member so that one can move the force measuring elements about the support member. The force measuring elements may also be inserted into the hem of the support member at various locations along the length and/or height of the hem. Adjustability for the location of the force measuring elements enables a comfortable fit for the user especially where other equipment, such as a helmet, must be placed over the impact monitoring apparatus of the present invention.

The support member is comprised of an elastic material such as any synthetic material that has flexibility and that can be stretched, e.g. spandex or elastane. The support member is comprised of a material that can be easily formed to the shape of a user's body part where impact is to be measured. The support member should also fit snugly on the user so that it will remain on the user and not fall off during use.

The present invention is also directed to an apparatus for registering the force of an impact to a user's head which includes a stretch fabric support for mounting proximate the head of a user, an accelerometer attachable to the support, and an indicator associated with the accelerometer for indicating the degree of acceleration experienced by the user's head resulting from the impact force. Another exemplary embodiment of the present invention is directed to an apparatus for indicating the force of an impact to a user's body part which includes a stretch fabric support detachably attachable to the user's body part and a force measuring element supported by the support having an indicator for indicating the degree of force of the impact in excess of a predetermined level.

### BRIEF DESCRIPTION OF THE DRAWINGS

The subject invention will hereinafter be described in conjunction with the appended drawing figures, where like numerals denote like elements, and

FIG. 1 is a schematic showing an exemplary embodiment of the impact monitoring apparatus of the present invention being worn by a user;

FIG. 2 is front view of the exemplary embodiment of the impact monitoring apparatus shown in FIG. 1 where the support member includes a pocket having a clear window and the force measuring element includes an indicator;

FIG. 3 is a perspective view of the pocket and force measuring element depicted in FIG. 2 showing the force measuring element having (which includes an indicator) being inserted into the pocket having a clear window shown;

FIG. 4 is a front view of another exemplary embodiment of the impact monitoring apparatus of the present invention for measuring the force of an impact to a user's head;

FIG. 5 is yet another exemplary embodiment of the impact monitoring apparatus of the present invention for measuring the force of an impact to a user's head; and

FIG. 6 is still another exemplary embodiment of the impact monitoring apparatus of the present invention for measuring the force of an impact to a user's head.

### DETAILED DESCRIPTION

The impact monitoring apparatus of the present invention generally provides a support member comprising an elastic type material where the support member can be attached to or worn by a user, and one or more force measuring elements that are attached to, or retained within, the support member. The apparatus can measure the force of impact to any part of a user's body. The support member of the impact monitoring apparatus of the present invention is comprised of an elastic type material that is light in weight, easily deformable, and capable of being easily worn by a user or attached to a user so that the impact monitoring can be positioned under other worn by the user. For example, one exemplary embodiment of the impact monitoring device of the present invention can be easily worn on a user's head underneath a helmet such as a football helmet, motorcycle helmet, or bicycling helmet.

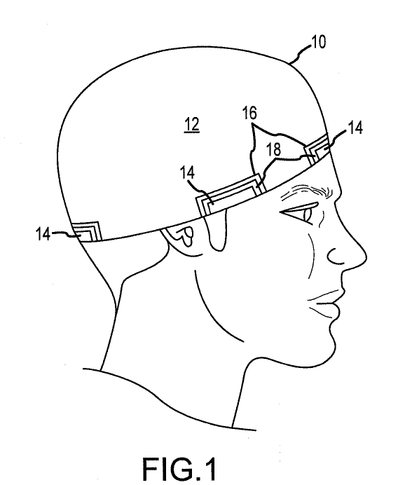

FIG. 1 is a schematic showing an exemplary embodiment of the impact monitoring apparatus of the present invention being worn by a user. The impact monitoring apparatus 10 includes a support member 12 and one or more force measuring elements 14 attached to, or retained within, the support member 12. Support member 12 shown in FIG. 1 is in the shape of a skull cap that is formed from a stretchable/elastic type of material having elastic properties. Support member 12 includes pockets 16 each having a clear window 18 so that force measuring elements 14 can be viewed and inspected by looking through windows 18. In addition to or as an alternative to pockets 16, support member 12 may also include one or more VELCRO fasteners for attaching the force measuring elements 14 to the support member 12. Support member 12 could also comprise a variety of other shapes, sizes, and configurations that can be attached to, or worn by, a user. For example, support member 12 could take the form of a headband, wristband, or knee support such as those worn by athletes.

Force measuring element 14 may include an indicator that is capable of indicating an amount of force of an impact that is experience by a user. For example, the force measuring elements 14 may comprise replaceable G-force liquid indicators such as those manufactured by ShockWatch located in Dallas, Tex. These indicators use the surface tension properties of a liquid in a specially engineered vial to indicate when excessive G-forces have occurred. More specifically, the force measuring element may comprise a receptacle (which may take the shape of a variety of forms) containing a colored liquid held in suspension with the indicator comprising the release of the colored liquid into the receptacle when the surface tension of the colored liquid is disrupted as a result of being exposed to an impact. When the force measuring element is subjected to an impact exceeding a specified G-level, the shock disrupts the surface tension of the liquid thereby releasing the colored liquid into the receptacle.

In general, for a support member such as that depicted in FIG. 1 (i.e. one that is worn on a user's head to measure the impact sustained by a user's head), a minimum of four indicators would be preferable (though fewer could be used) to indicate acceleration forces at the front, sides, and back of the head. The force measuring elements 14 may be held in place behind clear windows 18, or alternatively easily removable from their holding places, to allow for immediate inspection in the event a user suffers a questionable hit or fall.

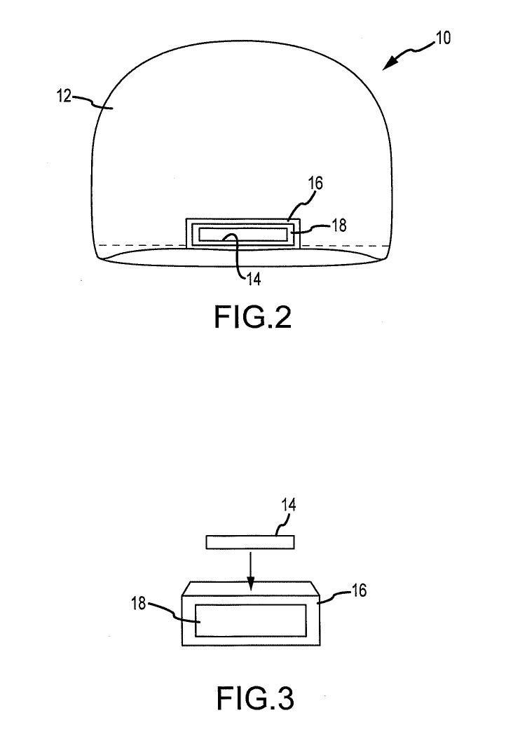

A front view of the exemplary embodiment of the impact monitoring apparatus 10 shown in FIG. 1 where the support member 12 includes a pocket 16 having a clear window 18 and the force measuring element 14 includes an indicator is shown in FIG. 2. The dotted lines represent seams sewn into support member 12. The support member 12 can be designed to allow for some adjustment in the location of the force measuring elements 14 in order to prevent the force measuring elements 14 from interfering with the comfort or fit of a piece of equipment (such as a helmet, for example) that is worn over the apparatus 10.

FIG. 3 is a perspective view of the pocket 16 and force measuring element 14 depicted in FIG. 2 showing the force measuring element 14 (which includes an indicator) indicator being inserted into the pocket 16 having a clear window 18. The indicator in the force measuring element 14 can be designed to trip or release at a specific G-force level. More than one force measuring element 14 could be installed at any specific location. For example, pocket 16 could contain two or more force measuring elements 14, each of which trip or release at a different G-level force. In general, trip or release settings will be between 10 Gs (i.e. 10 times the force of gravity) and 50 Gs with 10 Gs representing a mild impact and 50 Gs representing the equivalent of a heavy-weight fighter's punch. The force measuring elements 14 shown in FIGS. 1-3 are single use items. Once they are tripped or released, they are removed from the support member 12 and discarded. New force measuring elements 14 can then be placed into the pockets 16 of support member 12.

The impact monitoring apparatus of the present invention enables coaches and trainers to evaluate the status of the force measuring elements 14 and determine with some precision what impact forces a user's body is exposed to—especially the forces that are sustained by a user's head. Standard procedures and treatment methods can be developed with this information thereby eliminating the need for “judgment calls”. As a result, player safety will be improved and liability on the part of coaches and/or team staff can be eliminated. In addition, the impact monitoring apparatus of the present invention can be manufactured inexpensively (and therefore sold inexpensively) thereby making it easily affordable for high school contact sports such as football, hockey, lacrosse, etc.

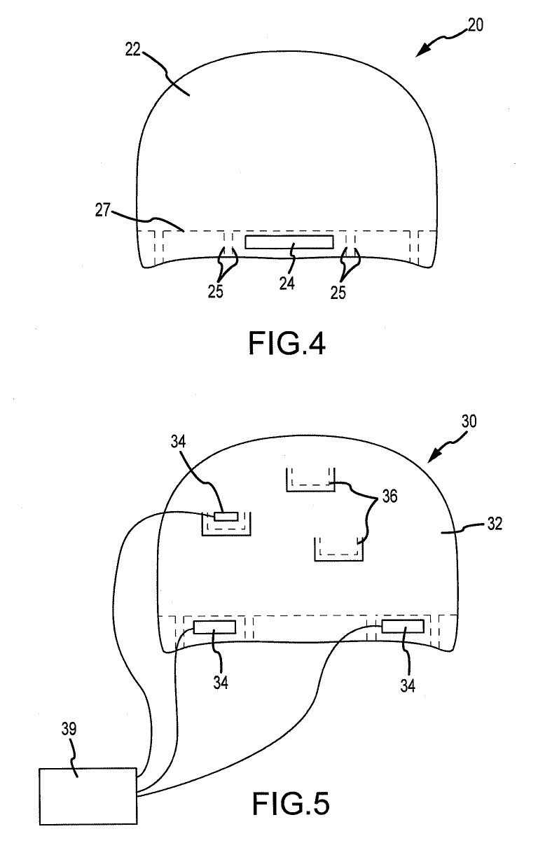

FIG. 4 is a front view of another exemplary embodiment of the impact monitoring apparatus 20 of the present invention for measuring the force of an impact to a user's head. Impact monitoring apparatus 20 includes support member 22 in the form of a skull cap and one or more force measuring elements 24 that are inserted into the seam (depicted by dotted lines) of support member 22. Small vertical seams 25 may be sewn perpendicular to the main seam 27 at the base of the skull cap to create small pockets within the seam running along the base of the skull cap. Insertion points for the pockets can be created by cutting slits into the area between the main seam 27 and the bottom of the skull cap. This enables force measuring elements 14 to be easily inserted and replaced along the length of the base of the skull cap. It is contemplated that many other configurations and elements for retaining the force measuring elements 24 within the support member 22 may be used that are already known in the art. In addition, the location of the force measuring elements 24 may be anywhere within or on the support member 22.

Yet another exemplary embodiment of the impact monitoring apparatus 30 of the present invention for measuring the force of an impact to a user's head is shown in FIG. 5. Impact monitoring apparatus 30 includes support member 32 in the form of a skull cap and one or more force measuring elements 34 that are inserted in both the base seam (seams indicated by dotted lines) of the support member 32 and pockets 36 sewn into or on the support member 32. In this exemplary embodiment, the force measuring elements 34 take the form of inertia switches which can be reset after being tripped and the impact monitoring apparatus 30 also includes a peak indicator circuit 39 which is connected to the force measuring elements 34. The inertia switches are actuated by an abrupt change in velocity of the support member 32 and their actuation is shown on the indicator circuit 39. Once actuated, the indicator circuit 39 would indicate permanently until reset. The indicator circuit 39 is compact enough to fit somewhere in a user's protective gear (e.g. the dead space in a user's helmet) or somewhere else on the user such as between a user's shoulder blades.

The indicator circuit 39 may be very simple (e.g. only indicating that a specific level of switch has been tripped) or more sophisticated (e.g. indicating which switches have been tripped). Indicating which switches are tripped allows evaluation of how much shock was absorbed by the skull. Use of switches as force measuring elements makes the impact monitoring apparatus of the present invention more robust in that it allows for the switches to be reused by re-setting them after they are actuated. The switches may also be automatically resetting enabling them to automatically reset if they were to trip as a result of rough handling such as in an equipment bag.

The switches 34 can be designed to trip or release at a specific G-force level. In addition, like the first exemplary embodiment, more than switch 34 could be installed at any specific location. For example, pocket 36 could contain two or more switches 34, each of which trip or release at a different G-level force. In general, trip or release settings will be between 10 Gs (i.e. 10 times the force of gravity) and 50 Gs with 10 Gs representing a mild impact and 50 Gs representing the equivalent of a heavy-weight fighter's punch. In addition, like the first exemplary embodiment, the support member 32 can be designed to allow for some adjustment in the location of the switches 34 in order to prevent the switches 34 from interfering with the comfort or fit of a piece of equipment (such as a helmet, for example) that is worn over the apparatus 30.

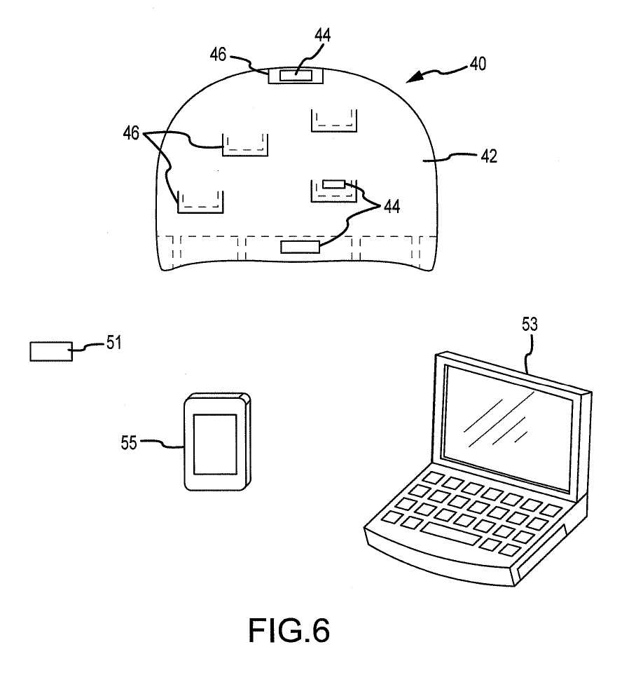

FIG. 6 is still another exemplary embodiment of the impact monitoring apparatus 40 of the present invention for measuring the force of an impact to a user's head. Impact monitoring apparatus 40 includes support member 42 in the form of a skull cap and one or more force measuring elements 44 that are inserted in both the base seam (seams indicated by dotted lines) of the support member 42 and pockets 46 sewn into or on the support member 42. In this exemplary embodiment, the force measuring elements 44 take the form of accelerometers, which measure G force, and include data collection and storage circuitry. The data measured and collected by the accelerometers 44 can be stored in the circuitry for later downloading to other data storage media (such as a memory stick 51) or may be transmitted wirelessly to other devices (such as a laptop computer 53 or a cell/smart phone 55). Wireless transmission may be performed by those methods currently known in the art. Wireless transmission of the force impact data would allow for real time analysis of the impact sustained by a user. This exemplary embodiment would be particularly useful for high-value collegiate or professional athletes.

Several variations and additions may be made to the impact monitoring device of the present invention. For example, a chin strap may be added to the embodiments shown in FIGS. 1, 2 and 4-5 to measure acceleration of the jaw. In addition, instead of the skull cap configuration of the support member shown in the exemplary embodiments, the support member may take the form of a balaclava (also known as a ski mask) which covers the whole head exposing only part of the face. This would allow the force measuring elements to be placed almost anywhere adjacent to the head which would be especially useful in motorsports where fire-resistant balaclavas are already in common use.

A sensor placed adjacent to the top of the head is also contemplated to measure accelerations associated with athletes who do not wear helmets such as soccer players who “head” a ball. The force measuring element and indicator (or recording system) could also be integrated directly into a helmet by positioning the force measuring elements on the padding (which would take the form of the support member) inside of the helmet that comes directly into contact with a user's head.

Other combinations and/or modifications of structures, arrangements, applications, proportions, elements, materials, or components used in the practice of the instant invention, in addition to those not specifically recited, can be varied or otherwise particularly adapted to specific environments, manufacturing specifications, design parameters, or other operating requirements without departing from the scope of the instant invention and are intended to be included in this disclosure.

Unless specifically noted, it is the Applicant's intent that the words and phrases in the specification and the claims be given the commonly accepted generic meaning or an ordinary and accustomed meaning used by those of ordinary skill in the applicable arts. It should be understood that the term force measuring element could be interchanged with the term sensor where the sensor is capable of sensing a specific level of force. In the instance where meanings differ, the words and phrases in the specification and the claims should be given the broadest possible, generic meaning. If any other special meaning is intended for any word or phrase, the specification will clearly state and define the special meaning.

1. An impact monitoring apparatus for the body comprising:
a support member comprising an elastic material capable of being attached to, or worn by, a user; and
one or more force measuring elements attached to, or retained within, the support member.

2. The impact monitoring apparatus of claim 1 wherein the one or more force measuring elements each include an indicator that is capable of indicating an amount of force of an impact that is experienced by the user.

3. The impact monitoring apparatus of claim 1 wherein the support member comprises at least one of a head band, a skull cap, or a balaclava for monitoring the impact sustained by a user's head.

4. The impact monitoring apparatus of claim 3 wherein the support member includes one or more VELCRO fasteners or one or more pockets for retaining the one or more force measuring elements.

5. The impact monitoring apparatus of claim 1 wherein the support member is easily removable from the user.

6. The impact monitoring apparatus of claim 2 wherein the one or more force measuring elements are easily removable from the support member.

7. The impact monitoring apparatus of claim 6 wherein the support member includes one or more clear windows through which the one or more force measuring elements can be visually inspected.

8. The impact monitoring apparatus of claim 2 wherein the one or more force measuring elements each comprise a receptacle containing a colored liquid held in suspension and the indicator comprises the release of the colored liquid into the receptacle when the surface tension of the colored liquid is disrupted when the user is subjected to an impact.

9. The impact monitoring apparatus of claim 1 wherein the one or more force measuring elements each comprise a switch.

10. The impact monitoring apparatus of claim 9 wherein each switch is actuated upon receiving a specific level of force.

11. The impact monitoring apparatus of claim 10 wherein each switch is capable of being automatically reset after being actuated.

12. The impact monitoring apparatus of claim 10 further comprising an indicator circuit that is connected to each of the switches.

13. The impact monitoring apparatus of claim 12 wherein the indicator circuit is not located on or within the support member.

14. The impact monitoring apparatus of claim 12 wherein the indicator circuit indicates the level of force received when a switch is activated.

15. The impact monitoring apparatus of claim 12 wherein the indicator circuit indicates which switches are activated.

16. The impact monitoring apparatus of claim 1 wherein the one or more force measuring elements each comprise an accelerometer.

17. The impact monitoring apparatus of claim 16 wherein each accelerometer includes circuitry capable of data collection and storage.

18. The impact monitoring apparatus of claim 17 wherein the circuitry is capable of downloading the data to other storage media.

19. The impact monitoring apparatus of claim 17 wherein the circuitry is capable of wirelessly transmitting the data in real-time so that real-time analysis of the data can be performed.

20. An apparatus for registering the force of an impact to a user's head comprising:
a stretch fabric support for mounting proximate the head of a user;
an accelerometer attachable to the support, and
an indicator associated with the accelerometer for indicating the degree of acceleration experienced by the user's head resulting from the impact force.

21. An apparatus for indicating the force of an impact to a user's body part comprising:
a stretch fabric support detachably attachable to the user's body part; and
a force measuring element supported by the support having an indicator for indicating the degree of force of the impact in excess of a predetermined level.
